(19) United States
(12) Patent Application Publication
(10) Pub. No.: US 2014/0333891 A1
(43) Pub. Date: Nov. 13, 2014

(54) 3D PRESCRIPTION SPECTACLE LENS AND METHOD OF MANUFACTURE

(71) Applicant: KILWORTH BUSINESS & PROPERTIES LTD, Leicester, Leicestershire (GB)

(72) Inventor: John Robert Boffey, Leicestershire (GB)

(21) Appl. No.: 14/362,174

(22) PCT Filed: Dec. 6, 2012
(86) PCT No.: PCT/GB2012/053027

§ 371 Date: Jun. 2, 2014

(30) Foreign Application Priority Data
Dec. 7, 2011 (GB) 1121019.2

(51) Int. Cl. G02B 27/26; B29D 11/00; B24B 9/20; G02C 7/02

(52) U.S. Cl. CPC G02B 27/26; G02C 7/022; B29D 11/00; B24B 9/20; G02C 2202/08; G02C 2202/16
USPC 351/159.01; 156/60; 451/28

(57) ABSTRACT

3D spectacles for prescription wearers include a dished lens blank to which is applied a dished 3D laminate blank of substantially the same shape. The composite is machined on edge and face to form a non-plan 3D spectacle lens. In order to prevent delamination during edge machining, the 3D laminate layer first may be breached in a direction perpendicular to the lens face.

### CROSS-REFERENCE TO RELATED APPLICATIONS

This application claims priority to International Application Serial No. PCT/GB2012/053027, filed Dec. 6, 2012, which claims priority to GB Application No. 1121019.2 filed Dec. 7, 2011. International Application Serial No. PCT/GB2012/053027 is hereby incorporated herein for all purposes by this reference.

### FIELD OF THE INVENTION

This invention relates to 3D Rx spectacle lenses, that is to say prescription lenses adapted to give a three-dimensional image to the wearer when watching a suitably enabled television or cinema screen.

### BACKGROUND

Plano 3D (non Rx) lenses employ passive polarized film in spectacle frames. Such lenses use a polarization technique to filter a visual signal to the left and right eyes, and thereby give the impression of three dimensions to a two-dimensional picture; they have no power, and consequently do not focus the image for the wearer.

Such plano 3D lenses are usually flat, and are formed by lamination and/or coating techniques from a thin flexible polarized film which is non-resilient. Tri-acetate cellulose is typically laminated to one or both sides of the film to give rigidity, and plano lenses are blanked from the flat laminate for mounting in spectacle frames. The resulting plano spectacles are often disposable, but more durable types are available for repeated use.

Plano 3D spectacles are acceptable for users who do not otherwise use spectacles. However they are much less acceptable for habitual wearers of prescription (Rx) spectacles because they are required to be worn in front of the prescription lenses. In this specification the terms ‘prescription’ and ‘Rx’ refer to lenses having a focussing power.

Such double wearing of spectacles causes considerable reduction of image quality and light transmission. In addition reflections and image artefacts may be generated on the surfaces of the lenses, and furthermore such 3D spectacles seldom remain in place because the nose and ear locations are occupied by the prescription spectacles. Double spectacles may also give a limited field of acceptable visual quality, typically through the centre of the lenses, so that the head of a wearer must be continually turned to follow on-screen action, rather than merely moving the eyes,

What is required is a lens or lens blank, which will permit the construction of 3D spectacles for prescription wearers, and thus be a substitute for normal prescription spectacles when viewing a 3D enabled image. However it is not possible to use conventional lamination techniques, whereby a flat 3D film is laminated to a lens blank, because these techniques cannot eliminate air bubbles, edge crinkling and other lamination defects which form as a consequence of the double plane curvature of a typical non-plano prescription lens. This effect is exacerbated in larger non-plano prescription lenses having a side to side dimension exceeding 50 mm.

### BRIEF SUMMARY OF THE INVENTION

In this specification the term ‘prescription 3D spectacle lens’ is used to identify a prescription lens having a polarizing film applied thereto, so as to permit a wearer to view suitable two dimensional images with some depth of image field.

According to a first aspect of the invention, there is provided a 3D lens blank for a prescription 3D spectacle lens, said 3D lens blank comprising a lens blank having a complex curve face, and a thermo formed dished 3D laminate blank fixed to the complex curve face of the lens blank by adhesive, the contacting surfaces of the lens blank and the 3D laminate blank having substantially the same profile.

By complex curve we mean a surface having curvature in two mutually perpendicular planes.

The lens blank typically has a curvature to the front face; the back face may be curved or flat. The back may be moulded to give a specified power. Commonly the lens blank is of substantially constant thickness. In use the back face of the lens blank is machined to form a prescription lens having the power required by the wearers spectacle prescription. The lens blank is of any suitable material, but is typically CR39 grade, optically clear plastic. Polycarbonate or grades known as K0055, JS-560ST, KR60T, MR7 and MR8 are potential alternatives.

The 3D laminate blank is typically formed from a rigid or rigidified sheet laminate of 3D polarized film and tri-acetate cellulose, for example of thickness 1.2 mm. The laminate may include other layers in order to give desired attributes. The flat sheet laminate is blanked, and the blanks are thermo-vacuum formed at an elevated temperature by conventional means into a permanent dished shape.

By shape matching the mating faces of the plano lens blank and the 3D laminate blank, the risk of air bubbles or delamination in the adhesive layer is substantially eliminated.

Preferably both the lens blank and 3D laminate blank are circular. In a preferred embodiment said blanks exceed 50 mm in diameter, and more preferably exceed 60 mm in diameter. Most preferably said blanks exceed 70 mm in diameter. The lens blank has a thickness in the range 10-15 mm, typically 12.5 mm.

The lens blank and the 3D laminate blank are preferably of the same diameter, but it is also possible for the relatively thin 3D laminate blank to be of a lesser diameter than the lens blank provided that the 3D laminate blank exceeds the maximum diameter of the spectacle lens to be machined from the 3D lens blank.

In one embodiment the lens blank is suitable for a varying lens powers typically up to ±6 diopters.

Preferably the 3D laminate blank is adhered to a convex surface of the lens blank, typically the front face.

According to a second aspect of the invention there is provided a 3D prescription spectacle lens machined from a circular 3D lens blank comprising an optically clear composite of a lens blank having a complex curve face, and a 3D laminate blank, said circular 3D lens blank being machined on the non-laminated side of the lens blank and around the periphery thereof.

Preferably the 3D lens blank is machined on the concave side to give the spectacle lens the required power.

According to a third aspect of the invention there is provided a method of adhering a circular, dished 3D laminate blank to a circular lens blank having a complex curve face, to form a composite blank, the method comprising the steps of:
a. providing an optically acceptable adhesive between mating curved faces of the blanks;
b. bringing the mating curved faces into contact to form a composite blank;
c. applying pressure to the inner and outer faces of the composite blank;
d. and curing the adhesive.

The lens blank is preferably dished, and the composite blank preferably has a spherical outer face.

Such a composite blank is suitable for machining to form a prescription spectacle lens. The adhesive may be cured by for example ultra-violet light and/or heat.

In a further step the method may include the step of applying heat and pressure in an autoclave. The method may include the step of providing a support surface on the 3D laminate blank prior to application of pressure, said support surface may have a dished profile corresponding to the composite blank. The method may include the step of placing the composite blank in an evacuated enclosure, prior to treatment in an autoclave.

For multiple composite lens manufacture, a suitable machined support surface may be provided, having a plurality of individual support surfaces in a grid-like pattern.

Once formed, the composite blank is usually face machined and polished, typically on the concave side, to give the required power; such a step may be done conventionally.

The composite blank must also be edge machined, typically by router or milling cutter, to shape the blank to the lens aperture of a spectacle frame. During such machining the multiple layers of the 3D laminate undergo shear loads which tend to shift or de-laminate the layers. Slower speed machining reduces production efficiency, and does not tend to eliminate this problem.

According to a fourth aspect of the invention there is provided a method of edge machining a circular composite lens blank comprising a laminate of a lens blank and a 3D laminate blank, said method comprising the steps of breaking through the 3D laminate in a direction substantially perpendicular to the plane thereof to form the shape of a spectacle lens, and edge machining the composite lens blank to reduce said blank to said shape.

Thus the 3D laminate layer is breached at least as far as the underlying lens layer so that the area bounded by the lens shape is not affected by subsequent edge machining. The 3D laminate layer may be broken through by any suitable method by which cutting forces do not impose shear loading, for example by knife, laser or water jet.

Such a technique is suitable for making both plano and non-plano 3D spectacle lenses, and avoids placing the 3D laminate layer(s) under shear loads.

In an alternative the edge machining may comprise dry machining of the composite blank to the required shape, in particular by rough milling to about 1 mm peripheral oversize, and finish milling to size. Dry machining has been found not to cause unacceptable edge delamination.

Prior to face or edge machining, the circular dished composite blank has a direction of polarization which is not apparent from visual inspection.

A manufacturing method of the invention comprises determining the direction of polarization of the composite blank, marking the blank to indicate said direction, and machining the blank on edge and face with reference to said marking to produce a 3D spectacle lens of known direction of polarization and hand (left or right).

The marking may be on the edge of the blank or on the face thereof. If on the face the marking may comprise a centre machining reference of the lens, for example in the form of a temporary attachment having an orientation. The attachment may be a removable sticker or label having printing or a cut-out thereon.

Other features of the invention will be apparent from the following description of several embodiments in which:

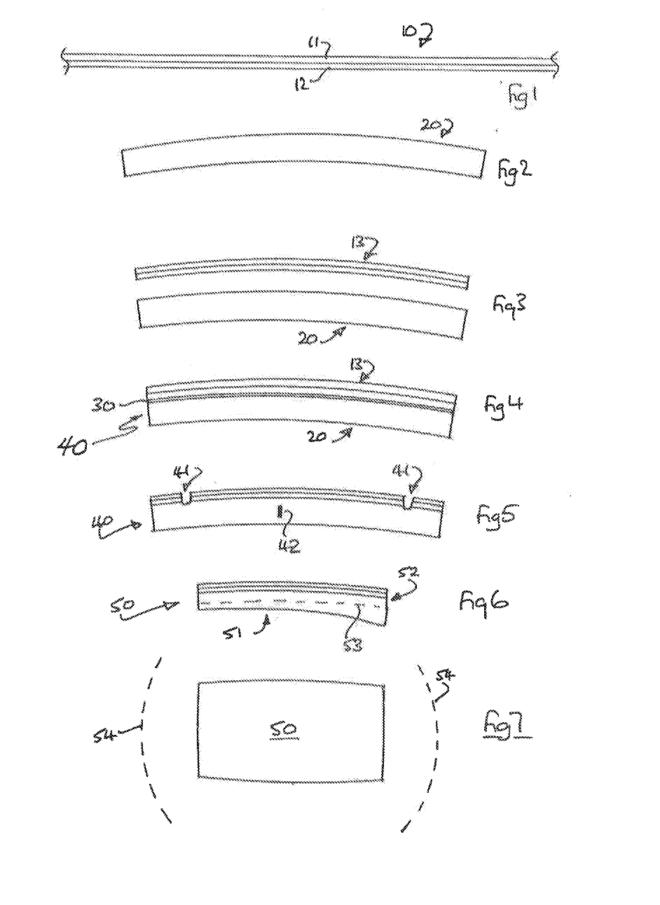

FIG. 1 represents a 3D film laminate.

FIG. 2 represents a plano lens blank for spectacles.

FIG. 3 represents a 3D laminate blank with a plano lens blank.

FIG. 4 represents the blank of FIG. 3 with adhesive interposed.

FIG. 5 represents the composite of FIG. 4 with lens profile in the film laminate layer.

FIG. 6 represents a fully machined spectacle lens.

FIG. 7 represents the lens of FIG. 6 in plan.

With reference to the drawings, in which certain dimensions are exaggerated to clearly illustrate feature thereof, FIG. 1 illustrates in side elevation a typical 3D film laminate 10, comprising a polarized film 11 for making 3D lenses, and an optically clear tri-acetate cellulose layer 12 for rigidifying the film 11. The laminate 10 is provided in continuous flat sheet form, for example as a roll, for the manufacture of conventional plano 3D lenses.

The laminate of FIG. 1 is simplified for the purposes of illustration, and may further comprise a layer of optically clear tri-acetate cellulose on the exposed polarized film 11, so that the film 11 is encased by a layer 12 on both sides. The purpose of the additional layer 12 is to protect the polarized film 11 from abrasion damage. A hard coating to further resist abrasion damage may additionally be applied to one or both outer surfaces of the film laminate 10. However, since one side is laminated to a lens blank, as will be described, a hard coating on this side may be considered superfluous.

FIG. 2 illustrates in side section a circular plano lens blank 20 having substantially the same curvature on the front and back faces. The lens blank 20 is typically of CR39, may be curved in two planes, and resemble a symmetrical dish.

FIG. 3 shows a circular 3D film blank 13 cut from the film laminate 10 and individually thermo-vacuum formed into a permanent dished form corresponding to the lens blank 20. The 3D film blank may be for example a square of about 75 mm side, or a circle of about 75 mm diameter. In one embodiment a square film blank 13 is cut from the laminate film 10 so that the direction of polarization is apparent from a straight edge. The 3D square film blank is then dished, and may be marked to indicate the direction of polarization. A circular 3D laminate blank is then cut from the dished 3D square film blank to match a circular lens blank 20.

Thermo vacuum forming consists of heating and slumping the 3D square film blank onto a dished former, whilst applying a vacuum through the former. The number and size of vacuum apertures, and the level of vacuum applied are selected empirically to give the desired shape without affecting the optical quality thereof. After cooling, the dished film 3D square blank 13 is removed for inspection, in particular to check that the desired dished shape (complex curvature, in two mutually perpendicular planes) has not been affected by residual stresses which may be present in the 3D laminate sheet 10 from which the blank is sheared.

The dishing of the 3D film blank 13 may eliminate stresses apparent from flat sheared film blanks, so that flat 3D film blanks which exhibit curvature after shearing (due to residual manufacturing stress) may nevertheless be shaped into dished 3D film blanks 13 of acceptable sphericity and quality. This process step accordingly eliminates the requirement for quality inspection after blanking but prior to dishing.

In one embodiment the dished former comprises a mirror finish dome having a curvature to, suit the lens blank 20. The dome is highly polished to ensure that the 3D laminate blank 13 remains optically perfect during dishing thereof.

FIG. 4 illustrates an adhering step in which an optically acceptable adhesive 30 is placed between the blanks 13, 20, and is cured under pressure to form a 3D composite circular blank 40.

Several methods of forming the composite blank 40 have been demonstrated to be successful.

In the autoclave method, the lens blank 20 is coated with adhesive, and the dished 3D film laminate blank 13 is applied in register with light pressure. This individual assembly is placed in a bag, for example of nylon, which is evacuated for treatment in an autoclave at a temperature of around 100° C. or slightly more. Clamping of the individual assembly in the autoclave is not necessary. The temperature must be sufficiently hot to allow the 3D laminate blank 13 and the lens blank 20 to exactly conform, but not be so hot as to affect the curvature or optical properties of the component parts. After the adhesive 30 is cured, the composite lens blank 40 is removed for finish machining. Many lens assemblies may be bagged and placed in the autoclave at the same time.

The direct pressure method applies adhesive 30 to the concave side of the dished 3D film blank 13, for example as a central blob of appropriate volume. This 3D film blank 13 is placed in a rigid dished former (before or after application of adhesive), and the lens blank 20 is applied in register followed by a resilient bung or rigid upper tool. The former is of the exact curvature of the lens blank 20, typically spherical. Pressure is applied to the bung or upper tool, for example via an overcentre clamp, of at least 200 kg force, and preferably around 400 kg force. The resilient bung allows use of a flat face on the clamp, and avoids the necessity of a convex clamp face which might require centring on the lens; this latter method is however an acceptable alternative.

The former (or lower tool) and the upper tool may both be of highly polished metal, for example steel or aluminium; in both cases a mirror finish is required so as to preserve the optical quality of the 3D lens blank 40. Where a rigid upper tool is provided, the curvature thereof should exactly match the corresponding curvature of the laminate blank.

The former may be concave or convex. A concave former allows the components to lie in a dish so that registration is somewhat easier, glue may however exude upwardly during clamping. A convex former requires careful positioning of the lens components, but glue will exude generally downwardly.

The adhesive 30 is cured and heat is applied, typically to raise the temperature of the clamped assembly above 70° C., more preferably above 90° C. for four hours. Upon release of the clamp, the 3D composite blank 40 is removed for finish machining.

Several kinds of adhesive 30 have been found suitable.

Momentive (™) O.P. is a UV optical bonding silicon having 99% light transmission and requiring UV light/heat at 2000 mJ/per cubic centimetre.

A liquid optically clear adhesive (grade DX3996-2KH) is a silicone modified acrylic requiring a curing energy of 1000-3000 mJ/per cubic centimetre.

The circular 3D blank 40 consisting of a cured composite of 3D film 13 and lens blank 20 is now ready for finishing machining.

FIG. 5 shows the composite circular 3D blank 40 in which the 3D film laminate 13 is broken through generally in a direction perpendicular to the plane of the lens, in the desired shape of a spectacle lens. A continuous trough 41 is illustrated, though a cut would serve equally well, to the intent that the 3D laminate 13 is breached without imposing shear stress thereon which is sufficient to cause delamination. Milling or use of a laser are appropriate methods of breaching the 3D laminate 13.

FIGS. 6 and 7 show a finished spectacle lens 50 in which the concave face 51 is machined to give the desired lens power and the edge 52 is machined to give the desired shape, corresponding to the shape represented by the trough 41. During edge machining, the area of 3D laminate 13 within the trough 41 is not subjected to shear loads.

Dotted line 53 represents the usual peripheral peak for engagement in a corresponding groove of a spectacle frame. Dotted line 54 shows (incompletely) the edge of the composite circular blank 40 which is machined away.

The lens machining steps of FIG. 6 can be performed in any order, but preferably edge machining is the final step prior to glazing of the spectacle frame, and by reference to a conventional centring mark provided on the lens 50.

As an alternative to first breaching the 3D laminate 13, it has been found that dry edge machining in two stages produces an acceptable finished spectacle lens 50 without risk of delamination. A roughing cut is first made to shape the composite blank 40 to about 1 mm oversize, followed by a finishing cut to the required size.

It should also be mentioned that prior to edge machining the composite blank 40 may require conventional machining on the concave side to give the required lens power. Such machining is generally wet (i.e. with liquid lubricant) and is followed by a polishing step. Such machining is not necessary if the blank is originally formed or moulded with the appropriate power.

Most importantly it has been found that the lamination methods described herein permit the composite blank 40 to be retained in a conventional fashion for high speed finish machining. In particular such finishing requires the lens to be retained by gripping the convex (film) surface, so that the concave surface can be machined. The shear strength of the bonded interface is sufficient to allow conventional high speed/high force finish machining without risking delamination of the film.

Between the steps of FIG. 4 and FIG. 5, polarizing orientation of the composite circular blank 40 is required in order that the finished lens 50 has the required polarizing effect. This may be achieved by rotating the circular blank 40 over a corresponding filter, and marking the edge of the blank 40 in a position corresponding to, for example, maximum light transmission or absence of light transmission. Such a marking 42 is shown in FIG. 5 and allows alignment of the circular lens blank 40 in a machining fixture prior to breaking through the 3D film laminate 13. If such marking is on the outer face of the lens 50 it may also constitute the centring mark for edge machining of the lens 50.

One example of 3D prescription spectacle lens manufacture will now be described in detail. It will be understood that cleanliness is paramount, and that any contamination could be determined to both bonding and surface finish. The following example relates to manufacture of a single laminated lens blank, and will accordingly require adaptation for mass production in quantity.

A convex former (lower tool) is selected to suit the concave curvature of the lens blank, and is thoroughly cleaned. A very thin plastic film laminate is placed over the former to protect the surface thereof. Such a film is termed a ‘surface saver’ and may be in silicone liner tape form, grade St-4005; such a tape is highly conformable and is used in conventional alloy blocking of lenses.

A concave upper tool is selected to suit the convex curvature of the lens blank 20, and is thoroughly cleaned. The upper tool and lower tool may have matching curvature if the lens blank 20 is of constant thickness.

Both the dished laminate blank 13 and the lens blank 20 are inspected for pitting, scratching and other defects, and the tooling is checked for correspondence with the curvature of the lens components. The lens blank 20 is preferably re-surfaced by polishing or machining to give a newly exposed convex surface for lamination.

The former is placed on the base of a suitable press, and the lens blank 20 placed on top in register, concave side down.

A two pack epoxy glue (e.g. Devcon clear 2 ton epoxy) is warmed prior to mixing by immersion in hot water (90-95° C.) for ten minutes. This ensures correct consistency.

Three tear drops of both epoxy components are placed on the convex centre of the lens blank 20, and thoroughly mixed for five seconds using a dull tipped plastic stirring stick.

The laminate blank 13 is placed onto the lens blank 20 in register, concave side down.

The upper tool is placed on the laminate blank 13, and the weight thereof tends to squeeze and distribute adhesive 30 between the lens blank 20 and laminate blank 13. Excess adhesive 30 may run out at the periphery. The amount of adhesive 30 may be increased or decreased to ensure complete distribution between the lens blank 20 and laminate blank 13 without excess.

The upper tool and former (lower tool) may be aligned by guides, as necessary, and are clamped tightly. By visual inspection, adhesive 30 may be seen to appear around the entire periphery of the laminated lens blank 40.

The laminated lens blank 40 is clamped under pressure for the period recommended by the adhesive manufacturer, which may be about eight hours. The tooling is then released, and the laminated lens blank 40 is inspected for flaws, such as air pockets and the like.

The plastic surface saver film on the former ensures that the former is not contaminated with adhesive; the film may be removed after opening the press, and disposed of.

Generally the laminated lens blank 40 will have an edge bead of cured adhesive, but be optically correct in the through direction.

An example of an edge machining method for a laminated lens blank 40 is now described. This method is described in relation to manufacture of a single prescription lens, and may be modified in mass production.

A standard technique is used for processing, as will become apparent. In particular conventional grinding and polishing steps are used to increase the power of the lens 50, and to form the raised edge for glazing. The following steps should be performed sequentially without significant time delays.

A laminated lens blank 40 produced by the method described above is inspected for flaws and defects. If acceptable, the blank 40 is immersed in warm water (about 40° C.) for about 10 minutes.

The laminated lens blank 40 is removed from the water bath and is then rough machined to a slight oversize using conventional alloy blocking techniques.

Glazing is performed using a conventional edger, such as a Huvitz Excelon edger.

The laminated lens blank 40 is loaded into the edger, which is set for a polycarbonate cycle with the edge bevel about 30% from the front.

Machining is dry, and the polycarbonate (CR39) of the lens layer turns to powder. The 3D laminate layer 13 may produce a string, and care must be taken to avoid this string from catching or interfering with the bevel machining tool. A suction extractor may be used.

The finished lens 50 is removed once edge machining is concluded and may be deburred by hand if necessary. Water may be used as a lubricant for polycarbonate, but the 3D laminate layer 13 should preferably be machined dry.

For machining the power into the concave side of the lens 50, which is generally performed prior to edge machining, the front face (3D layer) has a very thin plastic surface saver film applied to protect the face thereof. Two such layers may be applied for additional protection. The lens 50 is gripped conventionally on a stem by a low melting point alloy applied directly to the protective film on the convex side and machined to the desired power on the concave side. After machining the lens 50 is released from the alloy grip and inspected for clarity and defects.

Typically settings for a Huvitz Excelon edger are:
Rotation limit: roughing 10, finishing min. 3, finishing max. 9
Rotation speed: roughing PC15, finishing PC 15
Roughing Y speed: safe mode 0, normal 4
Bevel height: 0.1

Variations to the invention are possible within the scope of the appended claims and, unless stated otherwise, other conventional techniques used for manufacture and glazing of prescription lenses are generally applicable provided that care is taken to avoid delamination of the 3D laminate 13.

1. A 3D lens blank for a prescription 3D spectacle lens, said 3D lens blank comprising a lens blank having a complex curve face and a thermo formed dished 3D laminate blank fixed to the lens blank by adhesive, the contacting surfaces of the lens blank and the 3D laminate blank having substantially the same profile

2. A 3D lens blank according to claim 1, wherein the lens blank has substantially identical curvature to the front and back face.

3. A 3D lens blank according to claim 1, and of CR39 grade, optically clear plastic.

4. A 3D lens blank according to claim 1, wherein the 3D laminate blank is formed form a rigidified sheet laminate of 3D polarized film and tri-acetate cellulose.

5. A 3D lens blank according to claim 1, wherein the 3D laminate blank is thermo-vacuum formed at an elevated temperature into a permanent dished shape.

6. A 3D lens blank according to claim 1, wherein the lens blank and 3D laminate blank are circular.

7. A 3D lens blank according to claim 6, wherein the lens blank and the 3D laminate blank are of the same diameter.

8. A 3D lens blank according to claim 6, wherein the 3D laminate blank is of a lesser diameter than the lens blank.

9. A 3D lens blank according to claim 1, wherein the plano lens blank as a 4 base curve.

10. (canceled)

11. (canceled)

12. A 3D lens blank according to claim 1, wherein the lens blank has a convex surface and the 3D laminate blank is adhered to the convex surface of the lens blank.

13. A 3D prescription spectacle lens machined from a circular 3D lens blank comprising an optically clear composite of a lens blank and a 3D laminate blank, said circular 3D lens blank being machined on the non-laminated side of the lens blank and around the periphery thereof.

14. A 3D spectacle lens according to claim 13, said circular 3D lens blank being machined on the convex side to give the spectacle lens the required power.

15. A method of adhering a circular, dished 3D laminate blank to a circular dished lens blank to form a composite blank having an inner face and an outer face, the method comprising the steps of:
shape matching the mating dished faces of the dished 3D laminate blank and the dished lens blank;
providing an optically acceptable adhesive between the mating dished faces of the dished lens blank and the dished 3D laminate blank;
bringing the mating dished faces of the dished lens blank and the dished 3D laminate blank into contact with the optically acceptable adhesive to form the composite blank;
applying pressure between the inner and outer faces of the composite blank;
and curing the adhesive.

16. A method according to claim 15, wherein said adhesive is cured by application of heat.

17. A method according to claim 15, wherein said adhesive is squeezed during curing thereof.

18. A method according to claim 17, and including the step of applying pressure in an autoclave.

19. A method according to claim 17, and including the step of providing a support surface for the 3D laminate blank prior to application of pressure, said support surface having a corresponding dished profile.

20. A method of edge machining a circular dished composite lens blank that includes a laminate of a prescription lens blank adhered to a 3D laminate blank, said method comprising the steps of breaking through the 3D laminate blank in a direction substantially perpendicular to the plane thereof to form the shape of a spectacle lens, and edge machining the circular dished composite lens blank to reduce said circular dished composite lens blank to said shape.

21. A method of edge machining according to claim 20, and including the preparatory steps of determining the direction of polarization of the circular dished composite lens blank, marking the circular dished composite lens blank to indicate said direction, and machining the circular dished composite lens blank on edge and face with reference to said marking to produce a non-circular 3D spectacle lens of known direction of polarization.

22. A method according to claim 21, wherein said marking comprises application of a center machining reference to a face of the circular dished composite lens blank.
